(19) United States
(12) Patent Application Publication
(10) Pub. No.: US 2015/0070487 A1
(43) Pub. Date: Mar. 12, 2015

(54) METHOD AND A DEVICE FOR THE PURPOSE OF ELCTROLUMINESCENCE INSPECTION AND/OR PHOTOLUMINESCENCE INSPECTION

(71) Applicant: ISRA VISION AG, DARMSTADT (DE)

(72) Inventor: Okan Agbuga, Berlin (DE)

(21) Appl. No.: 14/399,242

(22) PCT Filed: Apr. 30, 2013
(86) PCT No.: PCT/EP2013/058999

§ 371 Date: Nov. 6, 2014

(30) Foreign Application Priority Data
May 9, 2012 (DE) 10 2012 104 086.9

(51) Int. Cl. G06T 7/00

(52) U.S. Cl. CPC G06T 7/0004
USPC 348/126

(57) ABSTRACT

A method and a device are described that implement electroluminescence inspection, photoluminescence inspection or both of an object capable of luminescence. During the inspection, the object is excited by the application of a voltage, by the irradiation of light or both so as to transmit electromagnetic radiation. The electromagnetic radiation is registered by an optical recording device and is outputted as an image. The image undergoes an evaluation, and possible faults of the object are determined in the image evaluation. Provision is made for the registration of the electromagnetic radiation by the recording device to be undertaken in at least two images in different spectral ranges.

The invention concerns a method and a device for electroluminescence inspection and/or photoluminescence inspection of an object capable of luminescence, for example a PN semiconductor, in particular a solar cell or a solar module, in which the object is excited by the application of a voltage or, more generally, by means of an electrical action, which includes, for example, the action of an electrical field, and/or by means of the irradiation of light so as to transmit electromagnetic radiation, for example light in the optical or non-optical waveband, in particular in the near-infrared waveband, in particular, for example, in the waveband between 800 nm and 2500 nm, and the electromagnetic radiation is registered by an optical recording device, in particular a camera, for example an area-scanning camera and/or a line-scanning camera, in particular a digital camera, and is outputted as an image.

In accordance with the invention the image undergoes an evaluation, in particular in a computing unit connected to the recording device. Possible faults of the object are determined in the image evaluation, in particular by checking the image, which is preferably digital, i.e. formed in terms of individual pixels, for typical fault structures, which in particular can be defined in terms of a spatial extent and/or intensity. In particular the arrangement for the purpose of recording the object excited into luminescence is arranged in a darkened recording chamber, since the luminescence effects only have a low light intensity.

The method proposed in accordance with the invention and the corresponding device for the purpose of luminescence inspection can be deployed in electroluminescence and/or photoluminescence applications, both in production methods, also on-line on a production line, and/or off-line, for example for development and research purposes. In accordance with the invention particularly practical areas of deployment are in semiconductors, thin layer technologies and all types of substrates. One particular example is in photovoltaic structures, such as for example solar cells or solar modules. However, the invention is not limited to this particular example.

Inspection with luminescence images uses the structure and properties of objects capable of luminescence, for example solar cells, which are based on a PN semiconductor junction, and utilizes the behavior of minority charge carriers on the P-(positive) and N-(negative) sides of the semiconductor. On the N-side of the object capable of luminescence the holes (positive charge carriers) are in the minority. On the P-side of the object capable of luminescence electrons are the minority charge carriers. If as a result of application of a junction voltage the minority charge carriers diffuse through the object capable of luminescence, a current is generated in the object capable of luminescence, which leads to the transmission of electromagnetic radiation from the object capable of luminescence.

Images of this radiation provide information concerning the quality and/or the properties of the object capable of luminescence; this has been explained using the example of a semiconductor element, although the invention is not limited to such objects, and is also suitable, for example, for the investigation of other objects capable of luminescence, for example general lattice structures.

A particularly preferred application concerns the luminescence inspection of solar cells, or more generally photovoltaic substrates, which can be designed as monocrystalline, quasi-monocrystalline, or multi-crystalline Si-solar cells and/or solar modules, thin films or concentrated solar cells (CPV—concentrating photovoltaics). If the photovoltaic substrate, in what follows also called a solar cell, is caused to transmit electromagnetic radiation as a result of diffusion of the minority charge carriers by means of external excitation, for example the application of a voltage, the electromagnetic radiation transmitted by the solar cell can be recorded by optical sensors or recording devices, which are sensitive to electromagnetic radiation of a wavelength of more than 800 nm. To this end area-scanning cameras in particular, but also line-scanning cameras, can be used to generate the luminescence images of the solar cells.

The intensities of the luminescence images, which preferably are recorded with low-noise and high-sensitivity cameras in the near-infrared region (i.e. wavelengths between approximately 800 nm and 2500 nm) are proportional to the number of minority charge carriers in each region of the solar cell, i.e. the object capable of luminescence, and this therefore allows conclusions to be drawn concerning the quality of the object capable of luminescence, or faults within the latter.

Methods of known art with conventional Si-CCD cameras by virtue of slow image recording are not suitable for high production rates, since these can only inspect a maximum of some 1400 solar cells per hour. This is because of the long exposure and readout times of the cameras. A direct consequence of these long exposure times is a considerable excitation stress on the solar cells, exerted onto the solar cells during the electroluminescence inspections, since the latter must be subjected to an excitation current over a comparatively long time, typically more than 600 ms, in order to excite the solar cell into transmission of the electromagnetic radiation during the duration of the exposure.

Moreover with conventional recording methods it is not possible to differentiate reliably between the types of faults detected. The weak intensity of the electromagnetic radiation transmitted is in particular responsible for this, because it does not allow a clear differentiation between dislocations in the semiconductor (grain boundaries, life-related phenomena, etc.) and areas of process faults (cracks or flaws, firing defects, finger intrusions, etc.). Dislocations in the semiconductor are typically darker than areas of process faults. In systems of known art these difficulties lead to high false detection rates of more than 2%.

These difficulties also lead on to the fact that the faults detected cannot be classified, since the various types of faults cannot be distinguished from one another with sufficient reliability. The evaluation algorithms are often also limited to a particular material, i.e. for example to mono-crystalline, multi-crystalline or quasi-monocrystalline structures, or thin-film layers.

The object of the invention is therefore to propose a method that, preferably with an increased processing speed, is able to detect the individual types of faults more reliably and to differentiate between them. This object is achieved in accordance with the invention by means of a method with the features of Claim 1, and a device with the features of Claim 10.

In the method of the type cited in the introduction provision is therefore made for registration of the electromagnetic radiation by the recording device, i.e. recording of the object after or during the excitation into luminescence, to be undertaken in at least two images in different spectral ranges, i.e. in various recorded ranges of wavelengths. Thus in accordance with the invention at least one (multi-spectral) dual recording of the object excited into luminescence is provided at different wavelengths, so that faults associated with particular wavelengths can be better and more reliably detected and identified. This enables also a more reliable classification of the fault candidates, and in particular a differentiation between intrinsic and extrinsic faults of the object. By means of multiple recordings the method can also be applied in the same manner for both electroluminescence methods and photoluminescence methods, wherein the spectral ranges can be adapted as necessary.

One option for the recording of the object excited into luminescence at different wavelengths is an appropriate parameterization of the recording device, which, for example, with appropriate operating voltages for the sensor-active surface, is sensitive to different wavelengths of electromagnetic radiation.

However, in a preferred embodiment of the method proposed in accordance with the invention, for the selection of the spectral ranges filters are provided at different wavelengths, i.e. ranges of wavelengths (spectral ranges) which are changed or replaced upstream of the recording device by means of a filter changer synchronized with the registration of the electromagnetic radiation, i.e. with recording of the images. By this means any spectral range can be flexibly selected over the whole sensor-active range of the recording device, wherein by means of suitable filters the bandwidth of the range of wavelengths can also be selectively selected.

Conveniently the filter changer can have a filter guide, in which the various filters are accommodated and which can be moved relative to the recording device, i.e. relative to the optics of the recording device, such that the optics of the recording device observe and record the object excited into luminescence through a different filter in each case.

In a preferred application of the inventively proposed method the inspection can cover a waveband of between 800 nm and 1800 nm, i.e. by the selection of suitable filters the latter can basically be detected as a range of wavelengths identified as the near-infrared range. This range is particularly suitable, for example, for the inspection of photovoltaic substrates. To cover this near-infrared region for the at least two recordings in accordance with the invention, suitable filters can cover, for example, one range of wavelengths around approximately 1150 nm, and another range of wavelengths around 1500 nm. Thus a low-pass filter at 1150 nm and a high-pass filter at 1500 nm can be used. The bandwidth of the filters can, for example, be such that a range of wavelengths between approximately 900 to 1150 nm in the one filter, and a range of wavelengths between approximately 1300 to 1600 nm in the other filter, are allowed to pass through. The corresponding recordings thus complement each other in their information with regard to the behavior in the two different ranges of wavelengths. By this means it is possible to differentiate clearly between, and thus classify, the types of faults actually occurring in photovoltaic substrates.

The same is true when using more than two filters, wherein the ranges of wavelengths of the various filters can then be designed to be fully separated and/or partially overlapping. In principle a still finer differentiation of types of faults can, of course, be achieved by using more filters, if still more different ranges of wavelengths are selectively investigated. This also represents an inventive solution, which in particular can be deployed in the case of applications that are not particularly time-critical.

If the inventively proposed method on the other hand is deployed on-line during a production process it is usually necessary to reduce the duration of an inspection such that the production process is not hindered by the inspection. In this case even the recording of only two different images in different ranges of wavelengths already allows a clear improvement in quality compared with the prior art; the latter usually only covers one recording of a range of wavelengths from 800 nm to 1100 nm with few sensitive sensors in the peak region of luminescence of solar cells.

In order to increase the overall speed of the inspection in accordance with a particularly preferred variant of the inventively proposed method, provision is made for an InGaAs-camera (indium-gallium-arsenide camera) to be used as the recording device. Instead of the usual SI-cameras, InGaAs-cameras have a significantly improved sensitivity precisely in the short-wave infrared (SWIR) range of wavelengths between approximately 800 nm and 2000 nm. The significantly improved sensitivity leads to a shorter image recording time and an improved signal-to-noise ratio, so that on the one hand the inspection duration for a recording is significantly shortened, and on the other hand an improved quality of recording is achieved.

By the recording of two images of the object excited into luminescence, in particular a solar cell, the speed of inspection can therefore be significantly increased and customized into the usual manufacturing processes. In many applications this also opens up the possibility of producing more than two recordings, in particular between three and five recordings, of the object excited into luminescence, which would enable a still finer analysis and classification of the faults.

In accordance with an inventively provided, particularly preferred, evaluation of the recorded images it is proposed that in an image of the object possible faults are identified as fault candidates, by reconstructing from a recorded image, i.e. a luminescence image, a fault-free luminescence image, and forming the difference between the recorded and reconstructed luminescence images. With such a difference formation non-typical structures of an image automatically remain as the possible fault candidates.

In pursuance of this inventive concept provision can then be made for identified fault candidates (be they identified in accordance with the present method, or in another manner) to be evaluated in the other image that was recorded in a different spectral range from the spectral range of the first image evaluated. Instead of the one other image a plurality of further images with further different spectral ranges can, of course, also be used as the basis of the evaluation, if so required. Such a procedure accelerates the evaluation in other ranges, since the ranges that are preferably to be evaluated are those that have already shown distinctive features in the first image. By means of the various images fault candidates, and information concerning the individual fault candidates, can therefore be collected and can be forwarded in accordance with the invention to a fault classification process, which can be executed, as can the image processing, in a computing unit connected to the recording device.

In accordance with a particularly preferred form of embodiment fault candidates determined from the first image are forwarded to the second image. Should fault candidates occur in the second image that did not emerge from the first image, these are forwarded to any further image that may be available, or to the fault classification process, which represents a type of final fault processing. If on the other hand in a following (second) image a fault candidate from the preceding (first) image can be reliably excluded, there is no need for this fault candidate to be further investigated in any further images. This procedure can be correspondingly applied for any number of images.

It is furthermore particularly advantageous to collect and represent the occurrence of faults, in particular of classified faults, where applicable resolved into fault classes, as a spatial fault distribution over time (that is to say, a fault frequency distribution). This allows an early detection of process faults. The classification of individual faults can be undertaken with the use of artificial intelligence methods, wherein for the database examples of fault types that have been studied and classified can be used as a basis. As a result of the classification the final categorization into fault types of the candidates identified in the images as flaws or cracks, short-circuits, finger intrusions, series resistances, dark regions, inactive regions, firing defects, dislocations, hot spots, scratches, or contour defects can be undertaken.

This collection of quality criteria can also be used to predict the electrical classification of the solar cells into various quality classes.

In accordance with the invention, and in accordance with a particularly preferred application of the proposed method, provision can also be made before the inspection, for example after setting up the device in the context of a first installation, or when converting to another product, for a calibration of the recording device to be executed with regard to sharpness, geometry/resolution and/or obscuration. In particular this calibration can be executed under the control of a program, either automatically or with the participation of the user.

For a particularly preferred sharpness adjustment the contrast and the standard deviation of a multiplicity of rectangular image regions are used to describe the sharpness. The user can, for example, be requested by the program to proceed slowly with the sharpness adjustments of the objective, manually or automatically, from one extreme position to the other extreme position. The program stores the optimal sharpness values and, where applicable, outputs a fault message if the sharpness adjustment is taking place too quickly. In a second stage the user is then requested to repeat this process, while the application compares the currently achieved sharpness with the best stored sharpness value, and indicates the arrival at the best sharpness point, and/or stops any further adjustment automatically. Alternatively this can be executed by means of a control system without any user participation.

In the context of a geometrical calibration a configuration file is modified in order to adapt the resolution information. This can be undertaken automatically or by the user. For this purpose in the context of the calibration the average reproduction rate (resolution) is calculated with the aid of a calibration target, wherein certain parameters are either adapted automatically, or possible fault sources, for example a dirty target or an incorrect distance between the object plane and the camera, are outputted as suggestions, if the reproduction rate that is determined does not correspond to the desired requirements.

Furthermore in the context of the calibration obscured images can be calculated, wherein the visible obscuration is mainly caused by obscuration of the camera lenses. A simple solution to the generation of obscured images is the use of illumination curves, which are provided by the lens manufacturer and describe the percentage reduction of the image brightness from the center of the image to the edges. In order to align the optical axis with the central point of the image appropriate offsets can be used.

If such lens information is not available images of spatial cells can be inventively recorded. A model is then trained using a training dataset from a plurality of random points, which specifies the location (X,Y) and the intensity, wherein the training set only consists of image points of the object. This training set can additionally be filtered to take into account luminescence-specific effects, such as a lower light emission at the edges of the cells. This model can then be used to generate an obscured image.

The inventively proposed method is particularly suitable for the inspection of monocrystalline, quasi-monocrystalline, or multi-crystalline Si-solar cells or solar modules, thin-film solar cells or thin-film layers and/or concentrated solar cells (CPV—concentrating photovoltaics, i.e. solar cells in which the incident light (solar radiation) is concentrated by lenses, such as, for example, Fresnel lenses).

Accordingly the invention also refers to a device for electroluminescence inspection and/or photoluminescence inspection of an object capable of luminescence, for example a PN semiconductor, in particular a solar cell or a solar module, with a device for exciting electroluminescence and/or photoluminescence in the object. A device for exciting electroluminescence can, in particular, be a power or voltage supply, or a device for the generation of an electrical field or similar. In particular a device for exciting photoluminescence can be an illumination device.

In accordance with the invention the device has a recording device and in particular a movable object holder for the purpose of holding the object and transporting it as necessary. The object holder can, for example, be a conveyor belt. Furthermore a computing unit is provided for the purpose of controlling the device and evaluating images of the object excited into luminescence that are recorded by the recording device. In accordance with the invention a filter changer is arranged between the object and the recording device with at least two filters of different spectral ranges, wherein the different filters can be positioned upstream of the recording device such that the object can be recorded by the recording device through one of the different filters in each case.

The computing unit for the purpose of executing the above described method, or parts thereof, is preferably equipped, in particular, with suitable program code means, which execute the inventively described method when executed on the computing unit.

In accordance with the invention a particularly preferred recording device can be an InGaAs-camera with a particularly sensitive region of sensitivity in the short-wave infrared range, i.e. in particular at wavelengths between approximately 800 and 2,000 nm.

In a preferred application provision is made for one filter to be selected in the waveband around 1150 nm and another filter in the range of wavelengths around 1500 nm, i.e. these have an appropriate spectral range around these wavelengths in which the electromagnetic radiation can pass through.

By means of the proposed method a multi-spectral dual luminescence imaging and inspection of objects, in particular of solar cells or solar modules, is therefore proposed in the context of the transition energy of photovoltaic substrates in various wavelengths between 800 nm and 900 1800 nm. For the purpose of selecting the various ranges of wavelengths an automatic filter changer is described, which has a plurality of filters, at least two, for high-speed applications, which filter changer can be adjusted so as to be synchronized with the recording device.

Further advantages, features and possible applications of the present invention ensue from the following description of an example of embodiment and the figures. Here all described and/or figuratively represented features per se, or in any combination, form the subject of the invention; this is also independently of their summary in the claims or their back references.

Here:

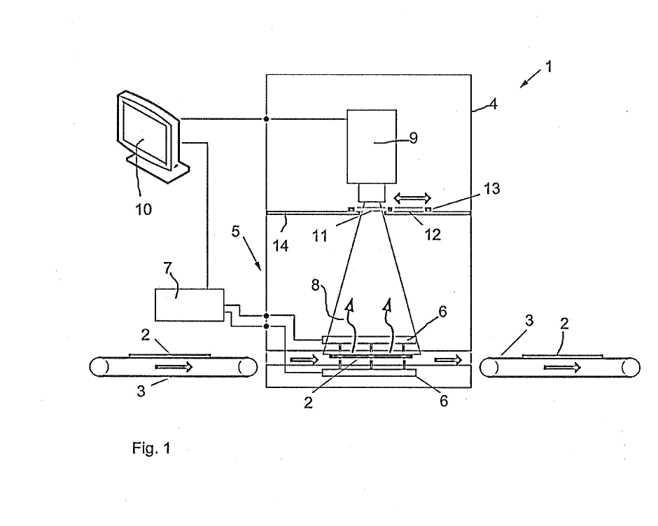

FIG. 1 shows the schematic structure of a device for the purpose of electroluminescence inspection in accordance with a preferred form of embodiment;

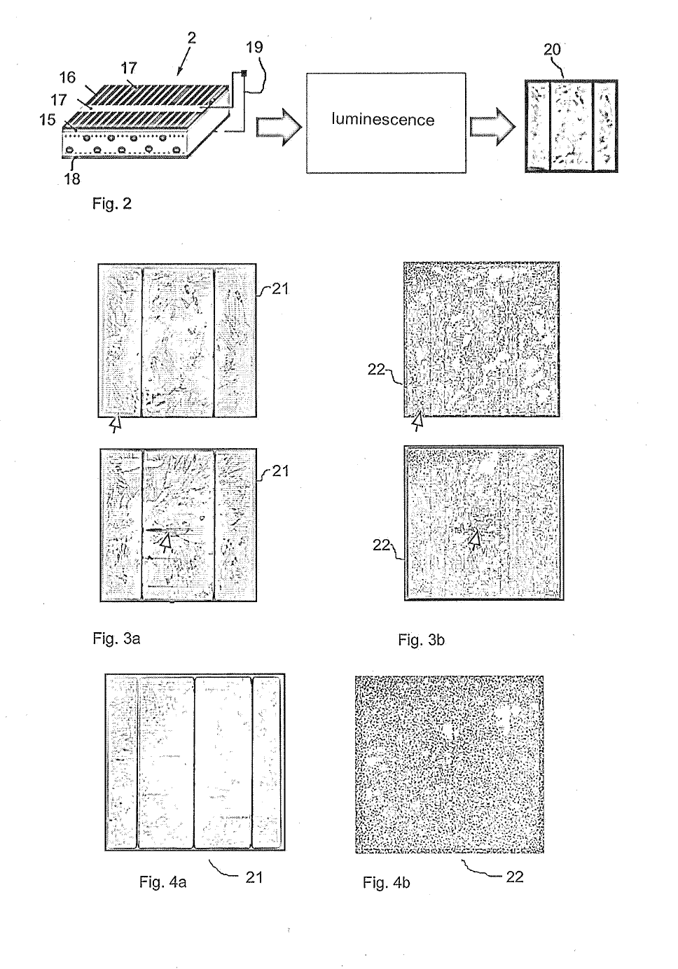

FIG. 2 shows schematically image capture with a device in accordance with FIG. 1;

FIG. 3a shows images captured with the device in FIG. 1 in a first spectral range;

FIG. 3b shows images captured with the device in FIG. 1 in a second spectral range;

FIG. 4a shows an image captured with the device in FIG. 1 in a first spectral range;

FIG. 4b shows an image captured with the device in FIG. 1 in a second spectral range;

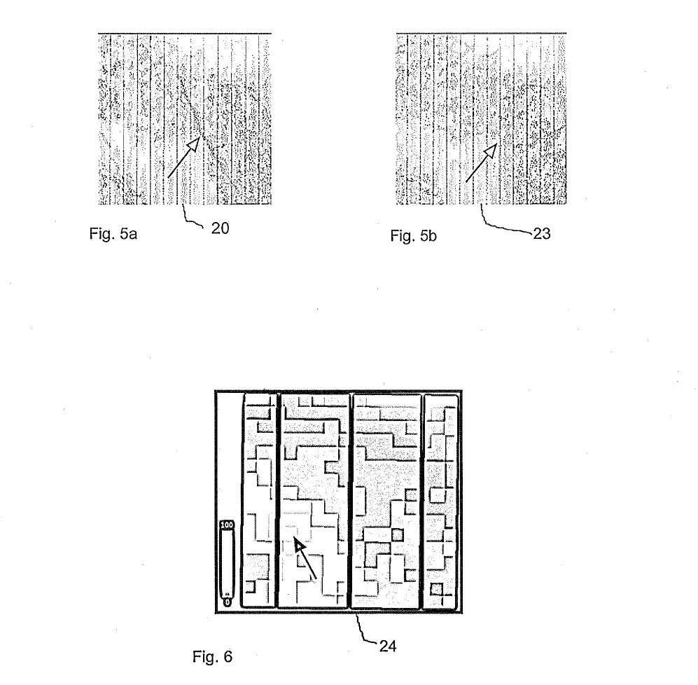

FIG. 5a shows an image recorded in the device in FIG. 1;

FIG. 5b shows a fault-free luminescence image reconstructed from the image in FIG. 4a; and

FIG. 6 shows a fault distribution (frequency distribution) formed in accordance with the invention.

FIG. 1 represents a preferred form of embodiment of the present invention. This shows a device 1 for the purpose of electroluminescence inspection of an object 2 capable of luminescence, which in the example represented is a solar cell. On a movable object holder 3, which is designed as a conveyor belt, and is arranged on a production line, the object 2 is guided into a darkened recording chamber 4, in which the solar cell 2 is positioned and connected with a device for the purpose of electroluminescence excitation 5. For this purpose contact elements 6 are provided in the darkened recording chamber 4; these make contact with the solar cell 2 on two faces, i.e. on its P-layer and its N-layer respectively, and by means of an energy supply 7 excite the junction voltage of the PN-junction in the solar cell 2 so that the latter—in a reversal of the actual photovoltaic effect—emits electromagnetic radiation 8.

In this application the electromagnetic radiation 8 represents infrared light in the range of wavelengths between approximately 800 nm and 1800 nm. This electromagnetic radiation 8 is recorded by a recording device 9, which particularly preferably is an InGaAs area-scanning camera and has a particularly high sensitivity to wavelengths between approximately 800 nm and 2000 nm. The images recorded by the recording device 9 are passed through to a computing unit 10, which controls the whole recording process and evaluates the recorded images in a manner that is described in more detail in what follows.

In order to be able to produce recordings of the solar cell 2, that is to say, of the light 8 emitted by the solar cell, selectively in different spectral images, two filters 11, 12 are arranged upstream of the recording device 9; by means of an automatic filter changer 13, which is synchronized with the recording device 9 controlled, for example, by means of the computing unit 10, and positions the one filter 11 or the other filter 12 in front of the recording device 9. For this purpose the automatic filter changer 13 can be moved in a synchronized manner with the recording device 9 on a frame 14, which also serves, for example, to cut off stray light.

With the device 1 at least two images are inventively recorded in different spectral ranges. For this purpose filter 11 can be a low-pass filter in a spectral range around 1150 nm and filter 12 can be a high-pass filter in the spectral range around 1500 nm, in order to record low and high spectral images in different wavelengths to measure the luminescence occurring at different energy transitions.

FIG. 2 shows the structure of the solar cell 2 and the image recording process in a schematic flow diagram. The solar cell 2 has a PN-type semiconductor 15 in which the minority charge carriers are arranged in each case on one face of the semiconductor, and in FIG. 2 are represented by small circles.

On the semiconductor 15 is located an antireflection SiO₂-layer 16, which is interrupted by conducting tracks forming a front contact 17. On the rear face of the PN semiconductor 15 is located a rear contact 18. If light impinges onto the solar cell 2, the minority charge carriers diffuse in the semiconductor 15 and generate a current, so that the current circuit 19 is closed and a current flows.

In the event of an electroluminescence inspection, in a reversal of this process, a voltage is applied to the front contact 17 and the rear contact 18, so that the charge carriers diffuse and, as represented in FIG. 1, emit electromagnetic radiation 8. This process is illustrated in FIG. 2 by a framed box. The result is that a recorded luminescence image 20 is obtained.

FIG. 3a shows luminescence images 21 of two different solar cells 2 recorded with a low-pass filter, in each of which dark pixels are represented, marked by means of a white arrow, which represent possible faults in the solar cell 2. In FIG. 3b, illustrated on the right next to FIG. 3a, images 22 are shown recorded with a high-pass filter for the same solar cells 2 in each case; overall these have a significantly darker structure and at points identified with the arrow allow a check of the fault candidates from the images 21 in FIG. 3a.

In the upper image cycle pictures 22 show no distinctive features. In contrast, in the lower image cycle in the region of the fault candidates in FIG. 3a particularly dark pixels can also be detected in FIG. 3b, which indicate process faults.

From suitable information concerning the intensity and shape of the individual regions it is therefore possible to draw reliable conclusions concerning the various faults. Bright regions in the images 22 in FIG. 3b indicate strong electron collectors (deep traps).

FIGS. 4a and b show two further examples of images that have been recorded from a solar cell 2 in a first spectral range (image 21) and in a second spectral range (image 22). In image 21, recorded in a first spectral range between approximately 900 nm and 1150 nm, a multiplicity of defect candidates appear as dark spots or lines. These regions are identified, for example, as described further below, and are investigated in more detail in the second image 22. The second image 22 was recorded in the spectral range between 1350 nm and 1600 nm. In this image 22 material defects (for example, dislocations), which originate in the material, and not from process faults, appear brighter, even though in the spectral range of the first image 21 they appear darker and have lower intensities, as do defect regions. These defects that appear brighter in image 22, which originate in the material, are not viewed as damaging for the quality and efficiency of the solar module, and can therefore be deleted from the list of fault candidates. However, this is only possible as a result of the inventive method using at least two images in different spectral ranges.

By virtue of the additional use of the InGaAs-camera it is possible to reduce the exposure time to 5 ms (compared with 500 ms in conventional facilities of known art). Also in the case of conventional facilities the readout time, by virtue of the need for multiple resolution, is comparatively long at 250 ms. In the inventive device the read-out time for the recording device 9 when using the InGaAs-camera can be reduced to the order of 33 ms. The recovery time of a camera (recording device 9) is typically less than 40 ms, compared with more than 750 ms per image in the case of conventional devices.

Despite a filter change time of the order of 100 ms, some 3600 solar cells can be inspected per hour by means of the inventive device, even though two images are recorded per solar cell. Conventional devices achieve (with only one recording per solar cell) only some 1400 cells per hour.

By means of the wave selective selection of a plurality of images the fault detection rate can be further depressed to less than 0.2%, in comparison to conventional systems with a fault rate of more than 2%. In particular the shorter recording time with the inventive device leads to less stress on the solar cells 2 during recording, since the latter only have to be excited into electroluminescence for a shorter, period of time.

In particular the following faults can be determined in solar cells 2: visible and invisible flaws or cracks, short-circuits, finger intrusions, series resistances, dark regions, inactive regions, firing defects, dislocations, hot spots, scratches, contour defects, etc. Moreover a prediction of the electrical classification of the modules, i.e. the quality class, can be determined.

FIGS. 5a and b illustrate a particularly preferred option for the purpose of localizing possible fault candidates in the images 20, 21, 22. FIG. 5a shows a recorded image 20 in which a long, dark, extended structure can be detected, marked by a white arrow, which forms a fault candidate. In order to be able to localize this fault particularly simply, the invention proposes that a luminescence image 23 that is free of faults, as it should be, be calculated from the recorded image 20. In the context of image evaluation the recorded luminescence image 20 is then subtracted from the fault-free, reconstructed luminescence image 23, as a result of which possible fault defect regions are automatically marked. These possible fault regions from a first recording are then further evaluated in the second and further images, which have been recorded with other filters 11, 12, for an exact decision as to whether a fault and, if necessary, which faults, are present.

In accordance with the invention the location and classification processes can be undertaken in five steps in accordance with a particularly preferred method sequence:

In a first step a simple optical correction is made by means of image processing, in which, in particular, an obscuration correction, a distortion correction, and/or various digital image-processing filters can be applied.

The second step then provides for the removal of regions of the image that are not to be investigated; in particular these can take the form of image background and busbars.

In the third step possible fault candidates are determined and assigned from the first image 21 (FIGS. 3a, 4a). The first image, in particular, can take the form of a recording in the so-called near-infrared region (approx. 900 to 1150 nm wavelength), in which most irregularities can be identified as dark sites. To this end, as described above, a fault-free luminescence image 23 is reconstructed from the recorded image.

For this purpose a spectral image is generated from the recorded image 20 by means of a Fourier transformation, in which the fault candidates can be assigned to particular frequencies. These supposed faults are removed by removing these frequency components from the spectral image. The spectral image is then transformed back into an optical image by means of an inverse Fourier transformation; the optical image then represents the reconstructed fault-free luminescence image. The recorded image 20 is then subtracted pixel-by-pixel from the luminescence image 23. Regions with gray value differences that exceed a prescribed threshold value, are classified as fault regions or fault candidates.

In a fourth step these fault regions or fault candidates are then forwarded to images of other spectral ranges and there checked, wherein the spectral ranges of the second or further images preferably have a longer wavelength than the first image investigated in the third step. In this step, for example some fault candidates can be identified as dislocations, which show up in the second image as brighter pixels. At the end of the fourth step these images can then be deleted from the list of fault candidates.

In the last, fifth step the remaining, i.e. not eliminated or deleted, fault candidates are forwarded to a fault classification process, which classifies the fault on the basis of the information collected in the various images and thereby defines the fault.

FIG. 6 shows finally a frequency distribution of faults (fault distribution) in a particular region of a solar cell 2 by means of a spatial distribution of faults accumulated over time. The dark regions show no or few faults, the bright region an average fault frequency and the region becoming dark once again a particularly high fault frequency in the vicinity of 100%. The lack of clarity in the gray coloring of the frequency distribution is to be attributed to the black-and-white reproduction of the figures. In real terms different colors can be used here so that a clear fault frequency can be detected in the figures.

The frequency distribution 24 shows the relatively greatest fault frequency in the region of the white arrow subsequently introduced into the frequency distribution 24. This indicates that a systematic process fault could be present here.

### REFERENCE SYMBOLS

1 Device for the purpose of electroluminescence inspection

2 Object capable of luminescence, solar cell

3 Object holder

4 Darkened recording chamber

5 Device for the purpose of electroluminescence excitation

6 Contact element

7 Energy supply, voltage supply

8 Electromagnetic radiation, IR light

9 Recording device

10 Computing unit

11 Filter with a first spectral range

12 Filter with a second spectral range

13 Automatic filter changer

14 Frame

15 PN-semiconductor

16 Antireflection and SiO₂-layer

17 Front contact

18 Rear contact

19 Current circuit

20 Recorded luminescence image

21 Luminescence image recorded with low-pass filter

22 Luminescence image recorded with high-pass filter

23 Fault-free luminescence image

24 Frequency distribution of the faults

1. A method for electroluminescence inspection, photoluminescence inspection or both, of an object capable of luminescence, the method comprising the steps of:
exciting the object by transmitting electromagnetic radiation in a form of a voltage, an irradiation of light, or both at the object,
registering the electromagnetic radiation using an optical recording device to generate and output an image, and
evaluating the image to determine possible faults of the object,
wherein the step of registering the electromagnetic radiation by the recording device is undertaken in at least two images in different spectral ranges.

2. The method in accordance with claim 1, further comprising using a selection of spectral range filters for different wavelengths, which filters are changed upstream of the recording device using a filter changer synchronized with the registration of the electromagnetic radiation.

3. The method in accordance with claim 1, wherein a range of wavelengths between 800 nm and 1800 nm is covered by the inspection.

4. The method in accordance with claim 1, wherein an InGaAs-camera is used as the optical recording device.

5. The method in accordance with claim 1, wherein possible faults in an image of the object are identified as fault candidates, by reconstructing a fault-free luminescence image from the image and forming a difference between the image and the reconstructed fault-free luminescence image.

6. The method in accordance with claim 5, wherein the identified fault candidates are evaluated in the reconstructed fault-free.

7. The method in accordance with claim 1, wherein an the occurrence of faults is collected in a spatial fault distribution.

8. The method in accordance with claim 1, further comprising, before the step of registering, calibrating the recording device with regard to any of the group consisting of: sharpness, geometry/resolution, obscuration and a combination thereof.

9. The method in accordance with claim 1, wherein the objects are any of the group consisting of: monocrystalline, quasi-monocrystalline, multi-crystalline Si-solar cells, monocrystalline, quasi-monocrystalline, multi-crystalline solar modules, thin-film solar cells, concentrated solar cells and a combination thereof.

10. A device for the purpose of electroluminescence inspection, photoluminescence inspection or both of an object capable of luminescence, comprising:
a device for exciting electroluminescence, photoluminescence or both in the object,
a recording device for recording images formed from the excited electroluminescence, photoluminescence or both in the object,
an object holder to hold the object and transport the object as necessary, and
a computing unit for controlling the device for exciting and evaluating the images recorded by the recording device of the object excited into the electroluminescence, photoluminescence or both,
a filter changer with at least two filters of different spectral ranges arranged between the object and the recording device,
wherein the different filters are (11, 12) can be positioned upstream of the recording device such that the object is recorded by the recording device through the different filters.

11. The device in accordance with claim 10, wherein the computing unit executes (10) the method of claim 1.

12. The device in accordance with claim 10, wherein the recording device (9) is an InGaAs-camera.

13. The device in accordance with claim 19, wherein one filter selects a range of wavelengths around 1150 nm and another filter selects a range of wavelengths around 1500 nm.
